(19) United States
(12) Patent Application Publication
(10) Pub. No.: US 2024/0171373 A1
(43) Pub. Date: May 23, 2024

(54) SIMILARITY CALCULATION SYSTEM, SIMILARITY CALCULATION APPARATUS, SIMILARITY CALCULATION METHOD, AND SIMILARITY CALCULATION PROGRAM

(71) Applicant: NEC Corporation, Minato-ku, Tokyo (JP)

(72) Inventors: Hiroto TAMIYA, Tokyo (JP); Toshiyuki ISSHIKI, Tokyo (JP); Kengo MORI, Tokyo (JP); Sanami NAKAGAWA, Tokyo (JP)

(73) Assignee: NEC Corporation, Minato-ku, Tokyo (JP)

(21) Appl. No.: 18/283,308

(22) PCT Filed: Mar. 23, 2021
(86) PCT No.: PCT/JP2021/011834

§ 371 Date: Sep. 21, 2023

(51) Int. Cl. H04L 9/00; G06F 7/544

(52) U.S. Cl. CPC H04L 9/008; G06F 7/5443

(57) ABSTRACT

A similarity calculation system calculating the similarity between a first vector and a second vector using homomorphic encryption having homomorphic operations defined with respect to at least one multiplication and a plurality of additions obtains the similarity between the first and the second vectors by using the homomorphic operations to calculate the inner product of the first encrypted vector obtained by using a public key for the homomorphic encryption to encrypt a row corresponding to the value of a component of the first vector extracted from a weighted similarity table of the similarity between each component of the first and the second vectors and the second encrypted vector obtained by transforming the value of a component of the second vector into a component in a unit vector that becomes 1 and encrypting the transformed result with the public key for the homomorphic encryption.

### TECHNICAL FIELD

The present invention relates to a similarity calculation system, similarity calculation apparatus, similarity calculation method, and similarity calculation program.

### BACKGROUND

Homomorphic encryption is a cryptographic technique. When ciphertexts Enc(m₁), Enc(m₂) of plaintexts m₁, m₂ are given, homomorphic encryption allows a ciphertext Enc(m₁∘m₂) of a binary operation m₁∘m₂ of the plaintexts m₁, m₂ to be computed without the ciphertext Enc(m₁∘m₂) being decrypted back into the plaintexts m₁, m₂. Here, “∘” is a binary operation such as addition “+” or multiplication “x.” Homomorphic encryption related to addition “+” is called additive homomorphic encryption. Further, homomorphic encryption that is also homomorphic with respect to multiplication “x” is called fully homomorphic encryption.

Fully homomorphic encryption has the best properties because it is homomorphic with respect to both addition and multiplication. However, fully homomorphic encryption presents difficulties in practical use as it requires a large amount of computation. Therefore, homomorphic encryption with intermediate properties between additive and fully homomorphic encryptions has also been developed. For instance, a cryptosystem called somewhat homomorphic encryption is an encryption scheme homomorphic with respect to a finite number of additions and multiplications (for instance, refer to Non-Patent Literature 1). Another example is two-level homomorphic encryption that allows one homomorphic multiplication and multiple homomorphic additions (for instance, refer to Non-Patent Literature 2). While somewhat homomorphic encryption and two-level homomorphic encryption only allow a limited number of operations, these schemes require less computation than fully homomorphic encryption. Therefore, the amount of computation can be reduced by selecting and implementing an appropriate homomorphic encryption scheme according to the application.

Similarity calculation is one of cryptographic protocols using such homomorphic encryption. The following describes similarity calculation using a film recommendation service as an application of similarity calculation. In a film recommendation service, when it is determined whether or not a film M* suits the taste of a user Y, computation is performed to find another user whose ratings for films other than the film M* are similar to the user Y's. More concretely, the similarity between the user Y and another user Uᵢ of the rating values for films M₁, M₂, . . . , Mₙ is calculated, and if the similarity is high, the users Y and Uᵢ are determined to also have similar ratings for the film M*. As a similarity metric, Euclidean distance or cosine similarity may be used, and an important requirement is to calculate the similarity while keeping the rating values of each user confidential. Homomorphic encryption is used in such a case where computation is performed while keeping the subject of the computation secret (for instance, refer to Patent Literatures 1 and 2).

### CITATION LIST

### Patent Literature

### [Patent Literature 1]

International Publication Number WO2017/061024A

### [Patent Literature 2]

Japanese Patent Kokai Publication No. JP2016-111594A

### Non-Patent Literature

### [Non-Patent Literature 1]

Yasuda M., Shimoyama T., Kogure J., Yokoyama K., Koshiba T. (2013) “Packed Homomorphic Encryption Based on Ideal Lattices and Its Application to Biometrics,” In: Cuzzocrea A., Kittl C., Simos D. E., Weippl E., Xu L. (eds), Security Engineering and Intelligence Informatics, CD-ARES 2013, Lecture Notes in Computer Science, vol 8128, Springer, Berlin, Heidelberg.

### [Non-Patent Literature 2]

Boneh D., Goh E. J., Nissim K., (2005) “Evaluating 2-DNF Formulas on Ciphertexts,” In: Kilian J. (eds), Theory of Cryptography, T C C 2005, Lecture Notes in Computer Science, vol 3378, Springer, Berlin, Heidelberg.

### SUMMARY

### Technical Problem

The disclosure of each literature in Citation List above is incorporated herein in its entirety by reference thereto. The following analysis is given by the present inventors.

When designing a similarity measure, weighting is sometimes performed. For instance, if the similarity of the rating values for the film M₁ is more important than that of the rating values for the film M₂, the similarity of the rating values for each film is weighted for evaluation. The so-called “weighted Euclidean distance” is an example of weighted similarity. In such a case, it is possible to calculate the similarity, using additive homomorphic encryption, while keeping the rating values of each user confidential. This is because, in additive homomorphic encryption, even computation with respect to a scalar multiple of a plaintext can be performed without decrypting the ciphertext.

Meanwhile, if weighting is performed more elaborately, computation using additive homomorphic encryption presents some problems. For instance, the rating values for a single film may be weighted differently, depending on whether the rating values are similar and favorable or they are similar and unfavorable. More concretely, let's say films are rated on a 0-5 scale with “5” being most favorable. The differences between “0” and “1” and between “4” and “5” are both 1, however, the difference between “4” and “5,” which are more favorable ratings, can be reflected more strongly in similarity.

To achieve this, a cryptosystem with better properties such as fully homomorphic encryption may be used instead of additive homomorphic encryption. Fully homomorphic encryption, however, requires a large amount of computation, as stated above. It is desirable to reduce the amount of computation while still achieving nonlinearly weighted similarity calculation.

In view of the problem above, it is an object of the present invention to provide a similarity calculation system, similarity calculation apparatus, similarity calculation method, and similarity calculation program that contribute to calculating nonlinearly weighted similarity without decrypting the ciphertext.

### Solution to Problem

According to a first aspect of the present invention, there is provided a similarity calculation system calculating the similarity between a first vector and a second vector using homomorphic encryption having homomorphic operations defined with respect to at least one multiplication and a plurality of additions, the similarity calculation system comprising: a similarity calculation apparatus that stores a first encrypted vector obtained by using a public key for the homomorphic encryption to encrypt a row corresponding to the value of a component of the first vector extracted from a weighted similarity table of the similarity between each component of the first and the second vectors; and a second input terminal that enters to the similarity calculation apparatus a second encrypted vector obtained by transforming the value of a component of the second vector into a component in a unit vector that becomes 1 and encrypting the transformed result with the public key for the homomorphic encryption, wherein the similarity calculation apparatus obtains encrypted similarity between the first and the second vectors by calculating the inner product of the first and the second encrypted vectors using the homomorphic operations.

According to a second aspect of the present invention, there is provided a similarity calculation apparatus calculating the similarity between a first vector and a second vector using homomorphic encryption having homomorphic operations defined with respect to at least one multiplication and a plurality of additions, the similarity calculation apparatus comprising: a storage part that stores a first encrypted vector obtained by using a public key for the homomorphic encryption to encrypt a row corresponding to the value of a component of the first vector extracted from a weighted similarity table of the similarity between each component of the first and the second vectors; a reception part that receives a second encrypted vector obtained by transforming the value of a component of the second vector into a component in a unit vector that becomes 1 and encrypting the transformed result with the public key for the homomorphic encryption; and an operation part that obtains encrypted similarity between the first and the second vectors by calculating the inner product of the first and the second encrypted vectors using the homomorphic operations.

According to a third aspect of the present invention, there is provided a similarity calculation method calculating the similarity between a first vector and a second vector using homomorphic encryption having homomorphic operations defined with respect to at least one multiplication and a plurality of additions, the similarity calculation method including: referring to a first encrypted vector obtained by using a public key for the homomorphic encryption to encrypt a row corresponding to the value of a component of the first vector extracted from a weighted similarity table of the similarity between each component of the first and the second vectors; receiving a second encrypted vector obtained by transforming the value of a component of the second vector into a component in a unit vector that becomes 1 and encrypting the transformed result with the public key for the homomorphic encryption; and obtaining encrypted similarity between the first and the second vectors by calculating the inner product of the first and the second encrypted vectors using the homomorphic operations.

According to a fourth aspect of the present invention, there is provided a similarity calculation program causing a computer to calculate the similarity between a first vector and a second vector using homomorphic encryption having homomorphic operations defined with respect to at least one multiplication and a plurality of additions, the similarity calculation program including: referring to a first encrypted vector obtained by using a public key for the homomorphic encryption to encrypt a row corresponding to the value of a component of the first vector extracted from a weighted similarity table of the similarity between each component of the first and the second vectors; receiving a second encrypted vector obtained by transforming the value of a component of the second vector into a component in a unit vector that becomes 1 and encrypting the transformed result with the public key for the homomorphic encryption; and obtaining encrypted similarity between the first and the second vectors by calculating the inner product of the first and the second encrypted vectors using the homomorphic operations. Further, this program can be stored in a computer-readable storage medium. The storage medium may be a non-transient one such as a semiconductor memory, a hard disk, a magnetic recording medium, an optical recording medium, and the like. The present invention can also be realized as a computer program product.

### Advantageous Effects of Invention

According to each aspect of the present invention, it becomes possible to provide a similarity calculation system, similarity calculation apparatus, similarity calculation method, and similarity calculation program that contribute to calculating nonlinearly weighted similarity without decrypting the ciphertext.

### BRIEF DESCRIPTION OF DRAWINGS

FIG. 1 is a block diagram showing a schematic configuration example of a similarity calculation system according to a first example embodiment.

FIG. 2 is a block diagram showing a schematic configuration example of a similarity calculation apparatus according to the first example embodiment.

FIG. 3 is a system flowchart of the similarity calculation system according to the first example embodiment.

FIG. 4 is a block diagram showing a schematic configuration example of a similarity calculation system according to a second example embodiment.

FIG. 5 is a block diagram showing a schematic configuration example of a similarity calculation system according to a third example embodiment.

FIG. 6 is a drawing showing an example of the hardware configuration of the similarity calculation apparatus.

### EXAMPLE EMBODIMENTS

Example embodiments of the present invention will be described with reference to the drawings. The present invention, however, is not limited to the example embodiments described below. Further, in each drawing, the same or corresponding elements are appropriately designated by the same reference signs. It should also be noted that the drawings are schematic, and the dimensional relationships and the ratios between the elements may differ from the actual ones. The dimensional relationships and the ratios between drawings may also be different in some sections.

### First Example Embodiment

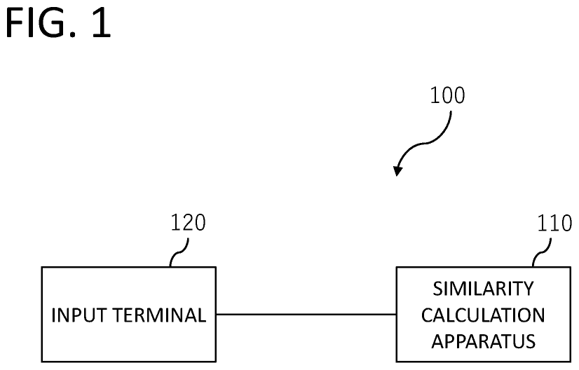

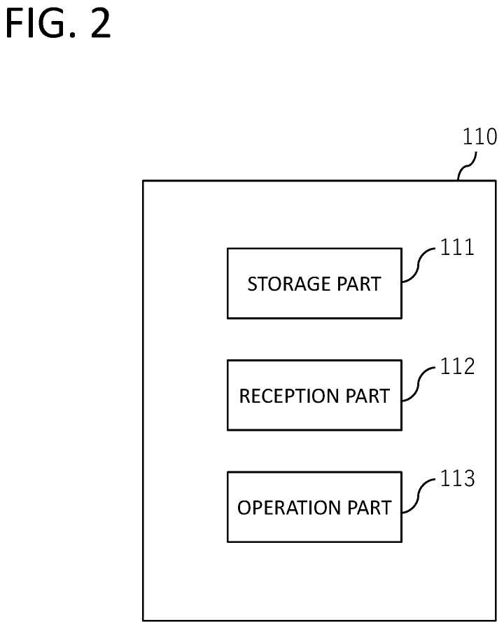

The following describes a similarity calculation system relating to a first example embodiment with reference to FIGS. 1 and 2. In the first example embodiment, only the basic concept of the present invention is described.

FIG. 1 is a block diagram showing a schematic configuration example of the similarity calculation system according to the first example embodiment. As shown in FIG. 1, the similarity calculation system 100 relating to the first example embodiment comprises a similarity calculation apparatus 110 and an input terminal 120. The similarity calculation apparatus 110 is an information processing apparatus (computer), the hardware configuration of which will be described using an example later. The input terminal 120 may be a stand-alone information processing apparatus (computer) or a device that is part of the similarity calculation apparatus 110. The similarity calculation apparatus 110 and the input terminal 120 may be connected by wired or wireless communication. For instance, the input terminal 120 may be a general-purpose personal computer or a mobile terminal such as a smartphone.

The similarity calculation system 100 relating to the first example embodiment shown in FIG. 1 calculates the similarity between a first vector and a second vector using homomorphic encryption having homomorphic operations defined with respect to at least one multiplication and a plurality of additions. The first vector (x₁, x₂, . . . , x_{i_num}) has each of its components xᵢ (i=1, . . . , i_num) taking values from 1 to S (i.e., xᵢ∈{1, 2, . . . , S}), and the second vector (y₁, y₂, . . . , y_{i_num}) also has each of its components yᵢ (i=1, . . . , i_num) taking values from 0 to S (i.e., yᵢ∈{1, 2, . . . , S}). Here, nonlinear weighting is allowed for the similarity between the first vector (x₁, x₂, . . . , x_{i_num}) and the second vector (y₁, y₂, . . . , y_{i_num}). Further, the nonlinear weighting here does not mean giving different constant weights to the components of the first vector (x₁, x₂, . . . , x_{i_num}) and the second vector (y₁, y₂, . . . , y_{i_num}), but it means that the weight value varies according to the value of each component x; or y.

The homomorphic encryption used in the first example embodiment may have homomorphic operations defined with respect to at least one multiplication and a plurality of additions. More concretely, in the homomorphic encryption used in the first example embodiment, homomorphic addition and homomorphic multiplication that satisfy the following relational expressions are defined:
Homomorphic Addition

HomAddₚₖ(Encₚₖ(m₁),Encₚₖ(m₂))=Encₚₖ(m₁+m₂)
Homomorphic Multiplication

HomMulₚₖ(Encₚₖ(m₁),Encₚₖ(m₂))=Encₚₖ(m₁×m₂)

FIG. 2 is a block diagram showing a schematic configuration example of the similarity calculation apparatus according to the first example embodiment. As shown in FIG. 2, the similarity calculation apparatus 110 comprises a storage part 111, a reception part 112, and an operation part 113. The storage part 111 stores a first encrypted vector obtained by using a public key for the homomorphic encryption to encrypt a row corresponding to the value of a first vector component extracted from a weighted similarity table of the similarity between each component of the first and the second vectors. The reception part 112 receives a second encrypted vector obtained by transforming the value of a second vector component into a component in a unit vector that becomes 1 and encrypting the transformed result with the public key for the homomorphic encryption. The operation part 113 obtains encrypted similarity between the first and the second vectors by calculating the inner product of the first and the second encrypted vectors using the homomorphic operations.

Next, the following describes a method for calculating the similarity between the first and the second vectors using the weighted similarity table. The description below concretely considers the i-th component of the first vector (x₁, x₂, . . . , x_{i_num}) and the second vector (y₁, y₂, . . . , y_{i_num}), and the same calculation method is applied to each component.

The weighted similarity table Tᵢ shows the similarity of the i-th component between the first and the second vectors. The value xᵢ of the i-th component of the first vector takes values from 1 to S, and the value yᵢ of the i-th component of the second vector takes values from 1 to S. Therefore, the weighted similarity table Tᵢ is an S×S table (matrix). An example of the weighted similarity table Tᵢ when S=5 is shown below. The table stores scores that decrease as the similarity between the value xᵢ of the i-th component of the first vector and the value yᵢ of the i-th component of the second vector increases.

TABLE 1
The Second Vector Values

| | | 1 | 2 | 3 | 4 | 5 |
|---|---|---|---|---|---|---|
| The | 1 | 0 | + 1 | +2 | +50 | +200 |
| First | 2 | +1 | 0 | +1 | +30 | +50 |
| Vector | 3 | +2 | +1 | 0 | + 1 | +30 |
| Values | 4 | +50 | +30 | +1 | 0 | +1 |
| | 5 | +200 | +50 | +30 | +1 | 0 |

Then, a row corresponding to the value xᵢ of the i-th component of the first vector is extracted from the weighted similarity table Tᵢ shown above. For instance, when xᵢ=2, the following 1×5 table is obtained.

TABLE 2

| | | | | | |
|---|---|---|---|---|---|
| 2 | + 1 | 0 | + 1 | +30 | +50 |

This 1×5 table can be thought of as a vector (1, 0, 1, 30, 50), and the first encrypted vector can be obtained by encrypting this vector (1, 0, 1, 30, 50) with the public key for the homomorphic encryption.

Further, the second encrypted vector is created by transforming the value yᵢ of the i-th component of the second vector into a component in a unit vector that becomes 1 and encrypting the transformed result with the public key for the homomorphic encryption. In other words, the second encrypted vector is obtained by encrypting a unit vector (0, . . . , 0, 1, 0, . . . ,), in which only the component of the value yᵢ is 1, with the public key for the homomorphic encryption. For instance, when yᵢ=5, the second encrypted vector is obtained by encrypting a unit vector (0, 0, 0, 0, 1).

With the first and the second encrypted vectors configured as described above, encrypted similarity between the first and the second vectors can be obtained by calculating the inner product of the first and the second encrypted vectors using homomorphic operations.

For instance, when the first encrypted vector is (1, 0, 1, 30, 50) and the second encrypted vector is (0, 0, 0, 0, 1), the inner product thereof is 50. This is an equivalent of extracting the component of xᵢ=2 and yᵢ=5 from the weighted similarity table Tᵢ. As a result, one can obtain the similarity between the first and the second vectors since the weighted similarity table Tᵢ indicates the similarity of the i-th component between the first and the second vectors. Note that the obtained similarity is encrypted since the calculation of the inner product is performed in an encrypted state. The encrypted similarity may be sent to a next process after it is decrypted or without being decrypted. This depends on the application of the obtained similarity.

TABLE 3
The Second Vector Values

| | | 1 | 2 | 3 | 4 | 5 |
|---|---|---|---|---|---|---|
| The | 1 | 0 | + 1 | +2 | +50 | +200 |
| First | 2 | +1 | 0 | +1 | +30 | +50 |
| Vector | 3 | +2 | +1 | 0 | +1 | +30 |
| Values | 4 | +50 | +30 | + 1 | 0 | +1 |
| | 5 | +200 | +50 | +30 | +1 | 0 |

Here, supplementary explanation is given with regard to the description concretely considering the i-th component of the first vector (x₁, x₂, . . . , x_{i_num}) and the second vector (y₁, y₂, . . . , y_{i_num}). For the sake of simplicity, the relationship between the i-th components and the (i+1)-th components is explained using an example when xᵢ=2, xᵢ₊₁=3, yᵢ=5, and yᵢ₊₁=4.

TABLE 4

| | The Second Vector's i-th | | | | | | | The Second Vector's (i + 1)-th | | | | | |
|---|---|---|---|---|---|---|---|---|---|---|---|---|---|
| | Component | | | | | | | Component | | | | | |
| | | 1 | 2 | 3 | 4 | 5 | | | 1 | 2 | 3 | 4 | 5 |
| The First | 1 | 0 | +1 | +2 | +50 | +200 | The First | 1 | 0 | +11 | +40 | +60 | +210 |
| Vector's | 2 | +1 | 0 | +1 | +30 | +50 | Vector's | 2 | +11 | 0 | +11 | +40 | +60 |
| i-th | 3 | +2 | +1 | 0 | +1 | +30 | (i + 1)-th | 3 | +40 | +11 | 0 | +11 | +40 |
| Component | 4 | +50 | +30 | +1 | 0 | +1 | Component | 4 | +60 | +40 | +11 | 0 | +11 |
| | 5 | +200 | +50 | +30 | +1 | 0 | | 5 | +210 | +60 | +40 | +11 | 0 |

As can be seen in the tables above, when the i-th components and the (i+1)-th components of the first and the second vectors are defined as xᵢ=2, xᵢ₊₁=3, yᵢ=5, and yᵢ₊₁=4, the similarity is 50+11=61 as far as the i-th components and the (i+1)-th components are concerned. The first and the second encrypted vectors for obtaining this value may be acquired by serially combining the values extracted for each component. More concretely, they can be obtained as follows:

TABLE 5
The First Encrypted Vector

| | | | | | | | | | | | |
|---|---|---|---|---|---|---|---|---|---|---|---|
| 2 | +1 | 0 | +1 | +30 | +50 | 3 | +40 | +11 | 0 | +11 | +40 |

(1, 0, 1, 30, 50, 40, 11, 0, 11, 40)
The Second Encrypted Vector

| | | | | | | | | | | | |
|---|---|---|---|---|---|---|---|---|---|---|---|
| 5 | 0 | 0 | 0 | 0 | 1 | 4 | 0 | 0 | 0 | 1 | 0 |

(0, 0, 0, 0, 1, 0, 0, 0, 1, 0)

The result of calculating the inner product of the first encrypted vector (1, 0, 1, 30, 50, 40, 11, 0, 11, 40) and the second encrypted vector (0, 0, 0, 0, 1, 0, 0, 0, 1, 0) obtained as described above is 61. Further, it is clear that this process can be performed for each component of the first vector (x₁, x₂, . . . , x_{i_num}) and the second vector (y₁, y₂, . . . , y_{i_num}).

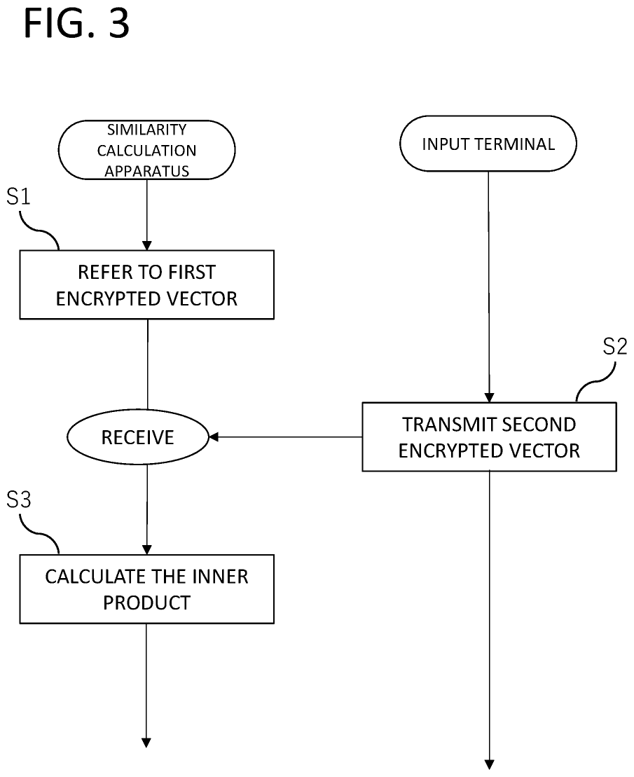

Next, with reference to FIG. 3, processes between the similarity calculation apparatus 110 and the input terminal 120 are described. FIG. 3 is a system flowchart of the similarity calculation system according to the first example embodiment. The system flowchart in FIG. 3 shows the procedure of the similarity calculation method for calculating the similarity between the first and the second vectors using homomorphic encryption having homomorphic operations defined with respect to at least one multiplication and a plurality of additions.

In step S1, the similarity calculation apparatus 110 refers to the first encrypted vector obtained by using a public key for the homomorphic encryption to encrypt a row corresponding to the value of a component of the first vector extracted from the weighted similarity table of the similarity between each component of the first and the second vectors. The first encrypted vector may be stored in the storage part 111 in the similarity calculation apparatus 110 or it may be stored in an external database server, instead of the similarity calculation apparatus 110. Further, the first encrypted vector may be supplied via the input terminal 120 or another input terminal.

In step S2, the input terminal 120 transmits to the similarity calculation apparatus 110 the second encrypted vector obtained by transforming the value of a component of the second vector into a component in a unit vector that becomes 1 and encrypting the transformed result with the public key for the homomorphic encryption.

Then, in step S3, the similarity calculation apparatus 110 obtains encrypted similarity between the first and the second vectors by calculating the inner product of the first and the second encrypted vectors using the homomorphic operations.

As described above, the similarity calculation system according to the first example embodiment is able to contribute to calculating nonlinearly weighted similarity without decrypting the ciphertext. Further, the similarity calculation system according to the first example embodiment may be implemented as a similarity calculation method, and the similarity calculation method according to the first example embodiment can be implemented as a program executed by an information processing apparatus (computer), the hardware configuration of which will be described later.

### Second Example Embodiment

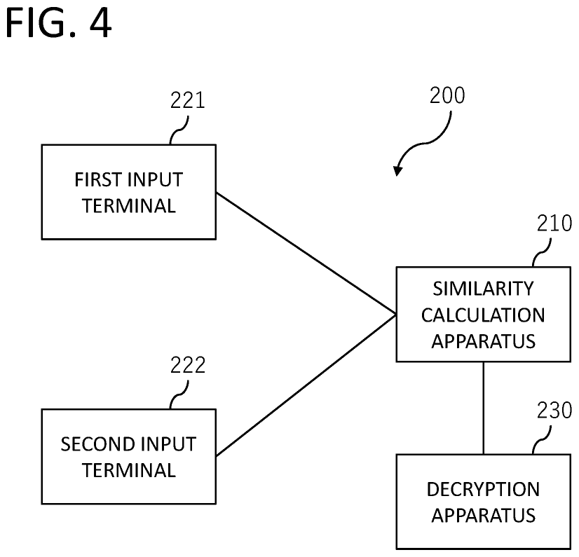

The following describes a similarity calculation system relating to a second example embodiment with reference to FIG. 4. The second example embodiment includes a concrete application of homomorphic encryption. Here, the second example embodiment is described using so-called two-level homomorphic encryption in which homomorphic operations are defined with respect to at least one multiplication and a plurality of additions. Note that the second example embodiment is not limited to two-level homomorphic encryption, and homomorphic encryption having homomorphic operations defined with respect to at least one multiplication and a plurality of additions, such as somewhat homomorphic encryption or fully homomorphic encryption, may be used.

As shown in FIG. 4, the similarity calculation system 200 relating to the second example embodiment comprises a similarity calculation apparatus 210, a first input terminal 221, a second input terminal 222, and a decryption apparatus 230. The similarity calculation apparatus 210 and the decryption apparatus 230 are information processing apparatuses (computers), the hardware configuration of which will be described using an example later. The first and the second input terminals 221 and 222 may be stand-alone information processing apparatuses (computers) or devices that are part of the similarity calculation apparatus 210. The similarity calculation apparatus 210, the first input terminal 221, and the second input terminal 222 may be connected by wired or wireless communication. For instance, the input terminal 220 may be a general-purpose personal computer or a mobile terminal such as a smartphone.

In the second example embodiment, the first vector (x₁, x₂, . . . , x_{i_num}) also has each of its components xᵢ (i=1, . . . , i_num) taking values from 1 to S (i.e., xᵢ∈{1, 2, . . . , S}), and the second vector (y₁, y₂, . . . , y_{i_num}) also has each of its components yᵢ (i=1, . . . , i_num) taking values from 0 to S (i.e., yᵢ∈{1, 2, . . . , S}). Nonlinear weighting is allowed for the similarity between the first vector (x₁, x₂, . . . , x_{i_num}) and the second vector (y₁, y₂, . . . , y_{i_num}), which is represented by the weighted similarity table Tᵢ that shows the similarity of the i-th component between the first and the second vectors. Further, the value of the j-th row and the k-th column of the weighted similarity table Tᵢ is notated as T_{i, j, k}.

For instance, the homomorphic encryption used in the second example embodiment may be the one described in Non-Patent Literature 2 having homomorphic operations defined with respect to at least one multiplication and a plurality of additions. In other words, in the homomorphic encryption used in the second example embodiment, homomorphic addition and homomorphic multiplication that satisfy the following relational expressions are defined. Further, in the homomorphic encryption used in the second example embodiment, the plaintext can be a scalar rather than a vector.
Homomorphic Addition

HomAddₚₖ(Encₚₖ(m₁),Encₚₖ(m₂))=Encₚₖ(m₁+m₂)
Homomorphic Multiplication

HomMulₚₖ(Encₚₖ(m₁),Encₚₖ(m₂))=Encₚₖ(m₁×m₂)

As preparation for homomorphic encryption, a public key pk and a secret key sk where a plaintext space size s>s_score are provided. Note that the score space size s_score is a quantity that indicates how much a variable can move. The public key pk is used to generate a cipher that enables homomorphic operations from a scalar plaintext and to perform homomorphic operations on homomorphic encryption encrypted with the public key pk. Meanwhile, the secret key sk is used to decrypt the homomorphic encryption encrypted with the public key pk. Therefore, the public key pk is possessed by the similarity calculation apparatus 210 and the first and the second input terminals 221 and 222, and the secret key sk is possessed by the decryption apparatus 230.

The first input terminal 221 receives the public key pk and the first vector (x₁, x₂, . . . , x_{i_num}) as inputs and computes the first encrypted vector from the first vector (x₁, x₂, . . . , x_{i_num}). The first encrypted vector is obtained by using the public key for the homomorphic encryption to encrypt a row corresponding to the value xⱼ of the j-th component of the first vector extracted from the weighted similarity table Tᵢ, and since the homomorphic encryption used in the second example embodiment uses scalar plaintext, each component of the extracted row is encrypted. More concretely, the following first encrypted vector c₁ is obtained. The obtained first encrypted vector c₁ is transmitted to the similarity calculation apparatus 210.

$${c}_{1} = ( \begin{matrix}{Enc}_{p k} ( {T}_{1 , {x}_{1} , 1} ) , {Enc}_{p k} ( {T}_{1 , {x}_{1} , 2} ) , … , {Enc}_{p k} ( {T}_{1 , {x}_{1} , i \_ num} ) , … , \\ {Enc}_{p k} ( {T}_{i\_num , {x}_{i\_num} , 1} ) , {Enc}_{p k} ( {T}_{i\_num , {x}_{i\_num} , 2} ) , … , {Enc}_{p k} ( {T}_{i\_num , {x}_{i\_num} , i\_num} )\end{matrix} ) \qquad [ Math . 1 ]$$

The second input terminal 222 receives the public key pk and the second vector (y₁, y₂, . . . , y_{i_num}) as inputs and computes the second encrypted vector. The second encrypted vector is obtained by transforming the value yⱼ of the j-th component of the second vector (y₁, y₂, . . . , y_{i_num}) into a component in a unit vector that becomes 1 and encrypting the transformed result with the public key pk for the homomorphic encryption. Therefore, the second encrypted vector c₂ is as follows. The obtained second encrypted vector c₂ is transmitted to the similarity calculation apparatus 210.

$${c}_{2} = ( \begin{matrix}{Enc}_{p k} ( {b}_{{y}_{1} , 1} ) , {Enc}_{p k} ( {b}_{{y}_{1} , 2} ) , … , {Enc}_{p k} ( {b}_{{y}_{1} , i \_ num} ) , … , \\ {Enc}_{p k} ( {b}_{{y}_{i\_num} , 1} ) , {Enc}_{p k} ( {b}_{{y}_{i\_num} , 2} ) , … , {Enc}_{p k} ( {b}_{{y}_{i\_num} , i\_num} )\end{matrix} ) , {b}_{i , j} = \{ \begin{matrix}0 & if i \neq j \\ 1 & if i = j\end{matrix} \qquad [ Math . 2 ]$$

The similarity calculation apparatus 210 calculates the inner product of the first and the second encrypted vectors using the homomorphic operations. However, since the first and the second encrypted vectors have each component thereof encrypted, the similarity calculation apparatus 210 performs the multiplication in the homomorphic operations on each component of the first and the second encrypted vectors and performs the addition in the homomorphic operations on each of the multiplied components. More concretely, the similarity calculation apparatus 210 first calculates cₘᵤ₁ shown below and then adds each component of cₘᵤ₁ using the homomorphic addition HomAddₚₖ to obtain a ciphertext c. The obtained ciphertext c is transmitted to the decryption apparatus 230.

$${c}_{mul} = ( \begin{matrix}{HomMul}_{p k} ( {Enc}_{p k} ( {T}_{1 , {x}_{1} , 1} ) , {Enc}_{p k} ( {b}_{{y}_{1} , 1} ) ) , … , \\ {HomMul}_{p k} ( {Enc}_{p k} ( {T}_{i\_num , {x}_{i\_num} , i\_num} ) , {Enc}_{p k} ( {b}_{{y}_{i\_num} , i\_num} ) )\end{matrix} ) \qquad [ Math . 3 ]$$

The decryption apparatus 230 uses the secret key sk to decrypt the ciphertext c computed using the homomorphic operations as described above. A value m obtained by decrypting the ciphertext c is the similarity between the first and the second vectors.

As described above, the similarity calculation system according to the second example embodiment is able to contribute to calculating nonlinearly weighted similarity without decrypting the ciphertext. Further, the similarity calculation system according to the second example embodiment has an advantage over the similarity calculation system according to a third example embodiment described later in that it does not require mask processing.

### Third Example Embodiment

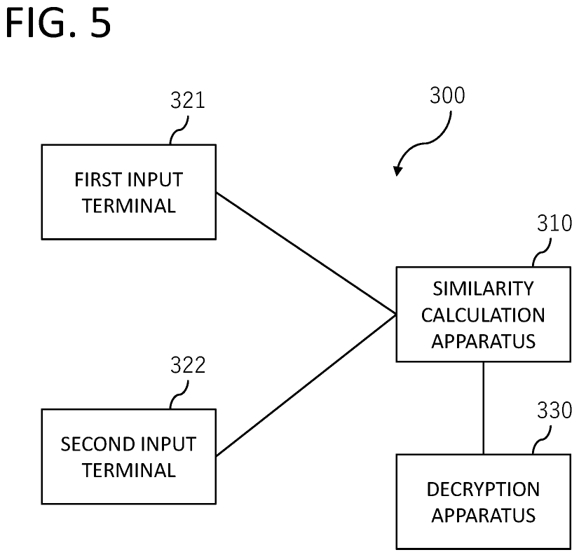

The following describes a similarity calculation system relating to the third example embodiment with reference to FIG. 5. The third example embodiment includes a concrete application of homomorphic encryption. Here, the third example embodiment is described using so-called somewhat homomorphic encryption in which encryption homomorphic with respect to a finite number of additions and multiplications is defined. Note that the third example embodiment is not limited to somewhat homomorphic encryption, and homomorphic encryption in which encryption homomorphic with respect to a finite number of additions and multiplications is defined, such as fully homomorphic encryption, may be used.

As shown in FIG. 5, the similarity calculation system 300 relating to the third example embodiment comprises a similarity calculation apparatus 310, a first input terminal 321, a second input terminal 322, and a decryption apparatus 330. The similarity calculation apparatus 310 and the decryption apparatus 330 are information processing apparatuses (computers), the hardware configuration of which will be described using an example later. The first and the second input terminals 321 and 322 may be stand-alone information processing apparatuses (computers) or devices that are part of the similarity calculation apparatus 310. The similarity calculation apparatus 310, the first input terminal 321, and the second input terminal 322 may be connected by wired or wireless communication. For instance, the input terminal 320 may be a general-purpose personal computer or a mobile terminal such as a smartphone.

In the third example embodiment, the first vector (x₁, x₂, . . . , x_{i_num}) also has each of its components xᵢ(i=1, . . . , i_num) taking values from 1 to S (i.e., xᵢ∈{1, 2, . . . , S}), and the second vector (y₁, y₂, . . . , y_{i_num}) also has each of its components yᵢ (i=1, . . . , i_num) taking values from 0 to S (i.e., yᵢ∈{1, 2, . . . , S}). Nonlinear weighting is allowed for the similarity between the first vector (x₁, x₂, . . . , x_{i_num}) and the second vector (y₁, y₂, . . . , y_{i_num}), which is represented by the weighted similarity table Tᵢ that shows the similarity of the i-th component between the first and the second vectors. Further, the j-th row of the weighted similarity table Tᵢ is notated as T_{i, j}.

In the third example embodiment, homomorphic encryption in which encryption homomorphic with respect to a finite number of additions and multiplications is defined, such as the one described in Non-Patent Literature 1, may be used. In other words, in the homomorphic encryption used in the third example embodiment, homomorphic addition and homomorphic multiplication that satisfy the following relational expressions are defined. Note that the homomorphic encryption used in the second example embodiment is a polynomial in which a plaintext is regarded as a vector. That is to say, the first vector (x₁, x₂, . . . , x_{i_num}) is regarded as m₁=x₁+x₂t¹+ . . . +x_{i_num}t^{i_num-1}, and the second vector (y₁, y₂, . . . , y_{i_num}) m₂=y₁+y₂t¹+ . . . +y_{i_num}t^{i_num-1}. The multiplication of the first vector (x₁, x₂, . . . , x_{i_num}) and the second vector (y₁, y₂, . . . , y_{i_num}) as plaintext is the polynomial m₁=x₁+x₂t¹+ . . . +x_{i_num}t^{i_nm-1} and the polynomial m₂=y₁+y₂t¹+ . . . +y_{i_num}t^{i_num-1}.
Homomorphic Addition

HomAddₚₖ(Encₚₖ(m₁),Encₚₖ(m₂))=Encₚₖ(m₁+m₂)
Homomorphic Multiplication

HomMulₚₖ(Encₚₖ(m₁),Encₚₖ(m₂))=Encₚₖ(m₁×m₂)

In the homomorphic encryption used in the third example embodiment, a homomorphic inner product operation can be defined as follows using the properties of polynomials and the homomorphic multiplication above. Note that Enc2ₚₖ(m₂) in Math. 4 below is encryption for the homomorphic inner product operation. Further, mᵢ* is a value in the plaintext space.

$${HomMul}_{p k} ( {Enc}_{p k} ( {m}_{1} ) , Enc {2}_{p k} ( {m}_{2} ) ) = {Enc}_{p k} ( 〈 {m}_{1} , {m}_{2} 〉 + {\sum }_{i = 1}^{n - 1} {m}_{i}^{*} {t}^{i} ) \qquad [ Math . 4 ]$$

As preparation for homomorphic encryption, provided are a public key pk and a secret key sk for somewhat homomorphic encryption that can treat an (n−1)-th degree polynomial (n≥i_num×S) with a coefficient space size s>s_score as plaintext. Note that the score space size s_score is a quantity that indicates how much a variable can move. The public key pk is used to generate a cipher that enables homomorphic operations from a scalar plaintext and to perform homomorphic operations on homomorphic encryption encrypted with the public key pk. Meanwhile, the secret key sk is used to decrypt the homomorphic encryption encrypted with the public key pk. Therefore, the public key pk is possessed by the similarity calculation apparatus 310 and the first and the second input terminals 321 and 322, and the secret key sk is possessed by the decryption apparatus 330.

The first input terminal 321 receives the public key pk and the first vector (x₁, x₂, . . . , x_{i_num}) as inputs and computes the first encrypted vector from the first vector (x₁, x₂, . . . , x_{i_num}). Since the first encrypted vector is obtained by using the public key for the homomorphic encryption to encrypt a row corresponding to the value xⱼ of the j-th component of the first vector extracted from the weighted similarity table Tᵢ, the first input terminal 321 first calculates a plaintext vector obtained by extracting a row corresponding to the value xⱼ of the j-th component of the first vector from the weighted similarity table Tᵢ. The resulting plaintext vector m₁ is shown below. Then, the first input terminal 321 encrypts the vector m₁ to obtain the first encrypted vector c₁=Encₚₖ(m₁). The obtained first encrypted vector c₁ is transmitted to the similarity calculation apparatus 310.

m₁=(T_{1,x}_{₁},T_{2,x}_{₂}, . . . ,T_{i_num,x}_{_{i_num}}) [Math. 5]

The second input terminal 322 receives the public key pk and the second vector (y₁, y₂, . . . , y_{i_num}) as inputs and computes the second encrypted vector. Since the second encrypted vector is obtained by transforming the value yⱼ of the j-th component of the second vector (y₁, y₂, . . . , y_{i_num}) into a component in a unit vector that becomes 1 and encrypting the transformed result with the public key pk for the homomorphic encryption, the second input terminal 322 first calculates a plaintext vector obtained by transforming the value yⱼ of the j-th component of the second vector (y₁, y₂, . . . , y_{i_num}) into a component in a unit vector that becomes 1. The resulting plaintext vector m₂ is shown below. Then, the second input terminal 322 encrypts the vector m₂ to obtain the second encrypted vector c₂=Enc2ₚₖ(m₂). The obtained second encrypted vector c₂ is transmitted to the similarity calculation apparatus 310.

$${m}_{2} = ( {B}_{{y}_{1}} , {B}_{{y}_{2}} , … , {B}_{{y}_{i\_num}} ) , {B}_{i} = ( {b}_{1} , {b}_{2} , … {b}_{l} ) , {b}_{j} = \{ \begin{matrix}0 & if j \neq {y}_{i} \\ 1 & if j = {y}_{i}\end{matrix} \qquad [ Math . 6 ]$$

Although the example above has the first encrypted vector as c₁=Encₚₖ(m₁) and the second encrypted vector c₂=Enc2ₚₖ(m₂), the result of the inner product operation is the same even with the first encrypted vector being c₁=Enc2ₚₖ(m₁) and the second encrypted vector c₂=Encₚₖ(m₂).

The similarity calculation apparatus 310 calculates the inner product of the first and the second encrypted vectors using the homomorphic operations. In a homomorphic inner product operation utilizing the product of polynomials, the constant term of the resulting polynomial is the inner product, but information may leak from terms other than the constant term. Therefore, terms other than the constant term representing the inner product are masked with random numbers.

More concretely, the similarity calculation apparatus 310 first calculates a polynomial ciphertext cᵢₚ=HomMulₚₖ(c₁, c₂) by homomorphically multiplying the first and the second encrypted vectors c₁ and c₂. Meanwhile, in order to mask non-constant terms, the similarity calculation apparatus 310 generates a random number vector r=(0, r₂, r₃, . . . , rₙ) in which uniform random numbers in the plaintext space are provided for the non-constant terms and creates a masking ciphertext cᵣ=Encₚₖ(r). Then, a ciphertext c=HomAddₚₖ(cᵢₚ, cᵣ) is obtained by homomorphically adding the polynomial ciphertext cᵢₚ and the masking ciphertext cᵣ. The obtained ciphertext c is transmitted to the decryption apparatus 330.

The decryption apparatus 330 uses the secret key sk to decrypt the ciphertext c computed using the homomorphic operations as described above. Note that a value m obtained by decrypting the ciphertext c is a polynomial and the constant term of this polynomial is the similarity between the first and the second vectors. Non-constant terms of the polynomial are also decrypted at the same time, however, since they are masked with the random number vector r=(0, r₂, r₃, . . . , rₙ) as described above, information will not be leaked from the non-constant terms of the polynomial.

As described above, the similarity calculation system according to the third example embodiment is able to contribute to calculating nonlinearly weighted similarity without decrypting the ciphertext. Further, in the similarity calculation system according to the third example embodiment, the number of operations is kept to a minimum by using the inner product operation utilizing polynomial multiplication.

### [Hardware Configuration]

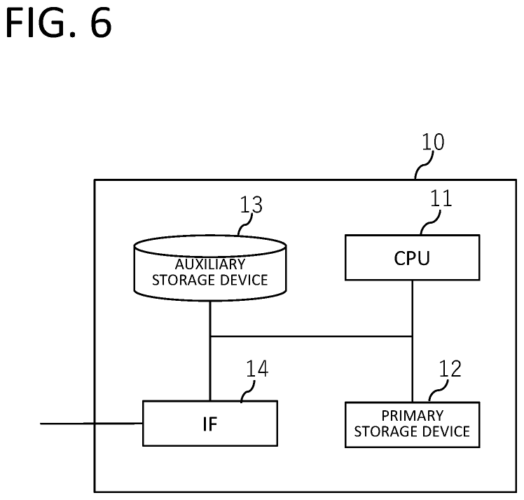

FIG. 6 is a drawing showing an example of the hardware configuration of the similarity calculation apparatus. In other words, the hardware configuration shown in FIG. 6 is an example of the hardware configuration of the similarity calculation apparatuses 110, 210, and 310.

An information processing apparatus (computer) employing the hardware configuration shown in FIG. 6 can achieve the functions of the similarity calculation apparatuses 110, 210, and 310 by executing the similarity calculation apparatus method described above as a program. It should be noted that the hardware configuration example shown in FIG. 6 is merely an example of the hardware configuration that achieves the functions of the similarity calculation apparatuses 110, 210, and 310, and is not intended to limit the hardware configuration of the similarity calculation apparatuses 110, 210, and 310. The similarity calculation apparatuses 110, 210, and 310 may include hardware not shown in FIG. 6.

As shown in FIG. 6, the hardware configuration 10 that may be employed by the similarity calculation apparatuses 110, 210, and 310 comprises a CPU (Central Processing Unit) 11, a primary storage device 12, an auxiliary storage device 13, and an IF (interface) part 14, which are connected to each other by, for instance, an internal bus.

The CPU 11 executes each instruction included in the similarity calculation program executed by the similarity calculation apparatuses 110, 210, and 310. The primary storage device 12 is, for instance, a RAM (Random Access Memory) and temporarily stores various programs such as the similarity calculation program executed by the similarity calculation apparatuses 110, 210, and 310 so that the CPU 11 can process the programs.

The auxiliary storage device 13 is, for instance, an HDD (Hard Disk Drive) and is capable of storing the various programs, such as the similarity calculation program executed by the similarity calculation apparatuses 110, 210, and 310, in the medium to long term. The various programs such as the similarity calculation program may be provided as a program product stored in a non-transitory computer-readable storage medium. The auxiliary storage device 13 can be used to store the various programs such as the similarity calculation program stored in the non-transitory computer-readable storage medium in the medium to long term. The IF part 14 provides an interface to the input and output between the similarity calculation apparatuses 110, 210, and 310 and the input terminals.

The information processing apparatus employing the hardware configuration 10 described above achieves the functions of the similarity calculation apparatuses 110, 210, and 310 by executing the similarity calculation method described above as a program.

Some or all of the example embodiments above can be described as (but not limited to) the following Supplementary Notes. For instance, the similarity may be the distance.

### [Supplementary Note 1]

A similarity calculation system calculating the similarity between a first vector and a second vector using homomorphic encryption having homomorphic operations defined with respect to at least one multiplication and a plurality of additions, the similarity calculation system comprising:
a similarity calculation apparatus that stores a first encrypted vector obtained by using a public key for the homomorphic encryption to encrypt a row corresponding to the value of a component of the first vector extracted from a weighted similarity table of the similarity between each component of the first and the second vectors; and a second input terminal that enters to the similarity calculation apparatus a second encrypted vector obtained by transforming the value of a component of the second vector into a component in a unit vector that becomes 1 and encrypting the transformed result with the public key for the homomorphic encryption, wherein
the similarity calculation apparatus obtains encrypted similarity between the first and the second vectors by calculating the inner product of the first and the second encrypted vectors using the homomorphic operations.

### [Supplementary Note 2]

The similarity calculation system according to Supplementary Note 1, wherein
the first and the second encrypted vectors have each component thereof encrypted, and
the similarity calculation apparatus performs the multiplication in the homomorphic operations on each component of the first and the second encrypted vectors and performs the addition in the homomorphic operations on each of the multiplied components.

### [Supplementary Note 3]

The similarity calculation system according to Supplementary Note 1, wherein
the first and the second vectors are polynomial coefficients,
the multiplication in the homomorphic operations is multiplication of the polynomials, and
the inner product is a constant term obtained by utilizing the multiplication of the polynomials.

### [Supplementary Note 4]

The similarity calculation system according to Supplementary Note 3, wherein
terms other than the constant term representing the inner product in a polynomial obtained from the multiplication in the homomorphic operations on vectors obtained from the first and the second vectors are masked with random numbers.

### [Supplementary Note 5]

The similarity calculation system according to any one of Supplementary Notes 1 to 4, wherein
a first encrypted vector is obtained by using a public key for the homomorphic encryption to encrypt a row corresponding to the value of a component of the first vector extracted from a weighted similarity table of the similarity between each component of the first and the second vectors and serially combining the encrypted results for each component of the first vector, and
a second encrypted vector is obtained by transforming the value of a component of the second vector into a component in a unit vector that becomes 1, encrypting the transformed result with the public key for the homomorphic encryption, and serially combining the encrypted results for each component of the second vector.

### [Supplementary Note 6]

The similarity calculation system according to any one of Supplementary Notes 1 to 5 further comprising a first input terminal that receives the first vector as an input to compute the first encrypted vector from the first vector and supplies the first encrypted vector to the similarity calculation apparatus.

### [Supplementary Note 7]

The similarity calculation system according to any one of Supplementary Notes 1 to 6 further comprising a decryption apparatus that decrypts the encrypted similarity between the first and the second vectors using a secret key for the homomorphic encryption.

### [Supplementary Note 8]

A similarity calculation apparatus calculating the similarity between a first vector and a second vector using homomorphic encryption having homomorphic operations defined with respect to at least one multiplication and a plurality of additions, the similarity calculation apparatus comprising:
a storage part that stores a first encrypted vector obtained by using a public key for the homomorphic encryption to encrypt a row corresponding to the value of a component of the first vector extracted from a weighted similarity table of the similarity between each component of the first and the second vectors;
a reception part that receives a second encrypted vector obtained by transforming the value of a component of the second vector into a component in a unit vector that becomes 1 and encrypting the transformed result with the public key for the homomorphic encryption; and
an operation part that obtains encrypted similarity between the first and the second vectors by calculating the inner product of the first and the second encrypted vectors using the homomorphic operations.

### [Supplementary Note 9]

A similarity calculation method calculating the similarity between a first vector and a second vector using homomorphic encryption having homomorphic operations defined with respect to at least one multiplication and a plurality of additions, the similarity calculation method including:
referring to a first encrypted vector obtained by using a public key for the homomorphic encryption to encrypt a row corresponding to the value of a component of the first vector extracted from a weighted similarity table of the similarity between each component of the first and the second vectors;
receiving a second encrypted vector obtained by transforming the value of a component of the second vector into a component in a unit vector that becomes 1 and encrypting the transformed result with the public key for the homomorphic encryption; and
obtaining encrypted similarity between the first and the second vectors by calculating the inner product of the first and the second encrypted vectors using the homomorphic operations.

### [Supplementary Note 10]

A similarity calculation program causing a computer to calculate the similarity between a first vector and a second vector using homomorphic encryption having homomorphic operations defined with respect to at least one multiplication and a plurality of additions, the similarity calculation program including:
referring to a first encrypted vector obtained by using a public key for the homomorphic encryption to encrypt a row corresponding to the value of a component of the first vector extracted from a weighted similarity table of the similarity between each component of the first and the second vectors;
receiving a second encrypted vector obtained by transforming the value of a component of the second vector into a component in a unit vector that becomes 1 and encrypting the transformed result with the public key for the homomorphic encryption; and
obtaining encrypted similarity between the first and the second vectors by calculating the inner product of the first and the second encrypted vectors using the homomorphic operations.

Further, the disclosure of each Patent Literature and Non-Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object thereof shall be considered to be included in the disclosed matters of the present application.

### REFERENCE SIGNS LIST

100, 200, 300: similarity calculation system
110, 210, 310: similarity calculation apparatus
111: storage part
112: reception part
113: operation part
120, 221, 222, 321, 322: input terminal
230, 330: decryption apparatus
10: hardware configuration
11: CPU (Central Processing Unit)
12: primary storage device
13: auxiliary storage device
14: IF (interface) part

What is claimed is:

1. A similarity calculation system calculating the similarity between a first vector and a second vector using homomorphic encryption having homomorphic operations defined with respect to at least one multiplication and a plurality of additions, the similarity calculation system comprising:
a similarity calculation apparatus that stores a first encrypted vector obtained by using a public key for the homomorphic encryption to encrypt a row corresponding to the value of a component of the first vector extracted from a weighted similarity table of the similarity between each component of the first and the second vectors; and
a second input terminal that enters to the similarity calculation apparatus a second encrypted vector obtained by transforming the value of a component of the second vector into a component in a unit vector that becomes 1 and encrypting the transformed result with the public key for the homomorphic encryption, wherein
the similarity calculation apparatus obtains encrypted similarity between the first and the second vectors by calculating the inner product of the first and the second encrypted vectors using the homomorphic operations.

2. The similarity calculation system according to claim 1, wherein
the first and the second encrypted vectors have each component thereof encrypted, and
the similarity calculation apparatus performs the multiplication in the homomorphic operations on each component of the first and the second encrypted vectors and performs the addition in the homomorphic operations on each of the multiplied components.

3. The similarity calculation system according to claim 1, wherein
the first and the second vectors are polynomial coefficients,
the multiplication in the homomorphic operations is multiplication of the polynomials, and
the inner product is a constant term obtained by utilizing the multiplication of the polynomials.

4. The similarity calculation system according to claim 3, wherein
terms other than the constant term representing the inner product in a polynomial obtained from the multiplication in the homomorphic operations on vectors obtained from the first and the second vectors are masked with random numbers.

5. The similarity calculation system according to claim 1, wherein
a first encrypted vector is obtained by using a public key for the homomorphic encryption to encrypt a row corresponding to the value of a component of the first vector extracted from a weighted similarity table of the similarity between each component of the first and the second vectors and serially combining the encrypted results for each component of the first vector, and
a second encrypted vector is obtained by transforming the value of a component of the second vector into a component in a unit vector that becomes 1, encrypting the transformed result with the public key for the homomorphic encryption, and serially combining the encrypted results for each component of the second vector.

6. The similarity calculation system according to claim 1 further comprising a first input terminal that receives the first vector as an input to compute the first encrypted vector from the first vector and supplies the first encrypted vector to the similarity calculation apparatus.

7. The similarity calculation system according to claim 1 further comprising a decryption apparatus that decrypts the encrypted similarity between the first and the second vectors using a secret key for the homomorphic encryption.

8. A similarity calculation apparatus calculating the similarity between a first vector and a second vector using homomorphic encryption having homomorphic operations defined with respect to at least one multiplication and a plurality of additions, the similarity calculation apparatus comprising:
a storage part that stores a first encrypted vector obtained by using a public key for the homomorphic encryption to encrypt a row corresponding to the value of a component of the first vector extracted from a weighted similarity table of the similarity between each component of the first and the second vectors;
a reception part that receives a second encrypted vector obtained by transforming the value of a component of the second vector into a component in a unit vector that becomes 1 and encrypting the transformed result with the public key for the homomorphic encryption; and
an operation part that obtains encrypted similarity between the first and the second vectors by calculating the inner product of the first and the second encrypted vectors using the homomorphic operations.

9. A similarity calculation method calculating the similarity between a first vector and a second vector using homomorphic encryption having homomorphic operations defined with respect to at least one multiplication and a plurality of additions, the similarity calculation method including:
referring to a first encrypted vector obtained by using a public key for the homomorphic encryption to encrypt a row corresponding to the value of a component of the first vector extracted from a weighted similarity table of the similarity between each component of the first and the second vectors;
receiving a second encrypted vector obtained by transforming the value of a component of the second vector into a component in a unit vector that becomes 1 and encrypting the transformed result with the public key for the homomorphic encryption; and
obtaining encrypted similarity between the first and the second vectors by calculating the inner product of the first and the second encrypted vectors using the homomorphic operations.

10. A non-transitory computer readable medium storing a similarity calculation program causing a computer to calculate the similarity between a first vector and a second vector using homomorphic encryption having homomorphic operations defined with respect to at least one multiplication and a plurality of additions, the similarity calculation program including:
referring to a first encrypted vector obtained by using a public key for the homomorphic encryption to encrypt a row corresponding to the value of a component of the first vector extracted from a weighted similarity table of the similarity between each component of the first and the second vectors;
receiving a second encrypted vector obtained by transforming the value of a component of the second vector into a component in a unit vector that becomes 1 and encrypting the transformed result with the public key for the homomorphic encryption; and
obtaining encrypted similarity between the first and the second vectors by calculating the inner product of the first and the second encrypted vectors using the homomorphic operations.

11. The similarity calculation apparatus according to claim 8, wherein
the first and the second encrypted vectors have each component thereof encrypted, and
the similarity calculation apparatus performs the multiplication in the homomorphic operations on each component of the first and the second encrypted vectors and performs the addition in the homomorphic operations on each of the multiplied components.

12. The similarity calculation apparatus according to claim 8, wherein
the first and the second vectors are polynomial coefficients,
the multiplication in the homomorphic operations is multiplication of the polynomials, and
the inner product is a constant term obtained by utilizing the multiplication of the polynomials.

13. The similarity calculation apparatus according to claim 12, wherein
terms other than the constant term representing the inner product in a polynomial obtained from the multiplication in the homomorphic operations on vectors obtained from the first and the second vectors are masked with random numbers.

14. The similarity calculation apparatus according to claim 8, wherein
a first encrypted vector is obtained by using a public key for the homomorphic encryption to encrypt a row corresponding to the value of a component of the first vector extracted from a weighted similarity table of the similarity between each component of the first and the second vectors and serially combining the encrypted results for each component of the first vector, and
a second encrypted vector is obtained by transforming the value of a component of the second vector into a component in a unit vector that becomes 1, encrypting the transformed result with the public key for the homomorphic encryption, and serially combining the encrypted results for each component of the second vector.

15. The similarity calculation method according to claim 9, wherein
the first and the second encrypted vectors have each component thereof encrypted, and
the similarity calculation method includes performing the multiplication in the homomorphic operations on each component of the first and the second encrypted vectors and performs the addition in the homomorphic operations on each of the multiplied components.

16. The similarity calculation method according to claim 9, wherein
the first and the second vectors are polynomial coefficients,
the multiplication in the homomorphic operations is multiplication of the polynomials, and
the inner product is a constant term obtained by utilizing the multiplication of the polynomials.

17. The similarity calculation method according to claim 16, wherein
terms other than the constant term representing the inner product in a polynomial obtained from the multiplication in the homomorphic operations on vectors obtained from the first and the second vectors are masked with random numbers.

18. The similarity calculation method according to claim 9, wherein
a first encrypted vector is obtained by using a public key for the homomorphic encryption to encrypt a row corresponding to the value of a component of the first vector extracted from a weighted similarity table of the similarity between each component of the first and the second vectors and serially combining the encrypted results for each component of the first vector, and
a second encrypted vector is obtained by transforming the value of a component of the second vector into a component in a unit vector that becomes 1, encrypting the transformed result with the public key for the homomorphic encryption, and serially combining the encrypted results for each component of the second vector.

19. The non-transitory computer readable medium storing the similarity calculation program according to claim 10, wherein
the first and the second encrypted vectors have each component thereof encrypted, and
the similarity calculation program includes performing the multiplication in the homomorphic operations on each component of the first and the second encrypted vectors and performs the addition in the homomorphic operations on each of the multiplied components.

20. The non-transitory computer readable medium storing the similarity calculation program according to claim 10, wherein
the first and the second vectors are polynomial coefficients,
the multiplication in the homomorphic operations is multiplication of the polynomials, and
the inner product is a constant term obtained by utilizing the multiplication of the polynomials.
